(19) United States
(12) Patent Application Publication
(10) Pub. No.: US 2018/0368213 A1
(43) Pub. Date: Dec. 20, 2018

(54) PRINTABLE HEATERS TO HEAT WEARABLES AND OTHER ARTICLES

(71) Applicant: E I DU PONT DE NEMOURS AND COMPANY, Wilmington (DE)

(72) Inventors: Mark Allan Lamontia, LANDENBERG, PA (US); MEHRDAD MEHDIZADEH, AVONDALE, PA (US)

(21) Appl. No.: 15/971,056

(22) Filed: May 4, 2018

Related U.S. Application Data
(60) Provisional application No. 62/522,260, filed on Jun. 20, 2017.

(51) Int. Cl. H05B 3/34

(52) U.S. Cl. CPC H05B 3/342; H05B 2203/011; H05B 2203/036; H05B 2203/017; H05B 2203/013

(57) ABSTRACT

This invention provides improved printed heaters to heat a variety of articles. The improvement comprises replacing the single large area resistive material layer with columns of a number of small patches of resistive material or of continuous resistive material, i.e., replacing the single large area heater with a number of smaller individual heaters. Printing of the resistive material is facilitated since the area of each resistive material patch is greatly reduced. In addition, some embodiments enable the opportunity to provide a breathable heater for use in wearable garments.

### FIELD OF THE INVENTION

This invention is directed to improved printable heaters for use in heating wearable garments, seats and parts of electric automobiles.

### BACKGROUND OF THE INVENTION

There is a need for heaters to heat articles such as wearable garments, seats and parts of electric automobiles.

There is increasing interest in providing heatable wearable garments. Currently typical commercialized heated garments are heated by resistance wires. These garments have the advantage that the areas between the wires allow the fabric to breathe. However, they have the disadvantage that the presence of the wires renders the garments uncomfortable.

An alternative is to use heaters with printed components which would provide greater comfort to the wearer. In one such version, a component of the heated garment is a layer of resistive material, e.g., carbon, which serves as the resistive heating element between two bus bars. Such a layer could cover a significant portion of the garment. It is difficult to print a large area resistive material layer with appropriate thickness and uniformity using currently available compositions. The resistance of such a heater is relatively high and batteries cannot deliver the power needed for a viable heater. The use of interdigitated electrodes with the large area resistive material can result in a considerable decrease in resistance. However, there is still the difficulty in printing the large area of resistive material. And in both of these approaches the large printed resistive material area can result in that portion of the garment not being breathable, i.e., not allowing water vapor transport, and this would be a source of discomfort for the wearer.

There is a need for improved heaters to heat articles such as wearable garments, seats and parts of electric automobiles

### SUMMARY OF THE INVENTION

This invention provides a printed heater comprising:
a) a substrate;
b) two printed bus bars;
c) an array of printed resistive material areas arranged in columns between the two bus bars with spaces between adjacent resistive material areas in a column and with a separation between adjacent columns, wherein the resistive material areas nearest to the bus bars overlap and are in electrical contact with the bus bars; and
d) an array of printed conductive areas, wherein a conductive area is positioned to fill the space between, to overlap, and to be contiguous to and provide electrical contact with every adjacent pair of resistive material areas in a column, wherein the portions of the resistive material areas along the column not in contact with the conductive areas form resistive regions that provide the heating and wherein the conductive areas and the bus bars can be printed onto the substrate before or after the resistive material areas.

The invention also provides a printed heater comprising:
a) a substrate;
b) two printed bus bars; and
c) an array of printed columns of resistive material between the two bus bars with a separation between adjacent columns, wherein the columns of resistive material overlap and are in electrical contact with each bus bar and wherein the bus bars can be printed onto the substrate before or after the resistive material columns.

The invention further provides a printed heater comprising:
a) a substrate;
b) two printed bus bars;
c) an array of printed columns of resistive material between the two bus bars with a separation between adjacent columns, wherein the columns of resistive material overlap and are in electrical contact with each bus bar; and
d) an array of printed conductive areas, wherein the conductive areas are positioned at intervals along each resistive material column to be contiguous to and provide electrical contact with the electrical resistive material column, wherein the portions of the resistive material along the column not in contact with the conductive areas form resistive tiles that provide the heating and wherein the conductive areas and the bus bars can be printed onto the substrate before or after the resistive material columns.

Therefore, the invention provides a heater comprising a plurality of individual heaters disposed in the described arrays. The much smaller areas of resistive material are more readily deposited.

This invention also provides articles containing heaters of each of the three configurations described above.

When the heater is in a wearable garment and the substrate on which the heater is printed is permeable, the exposed permeable substrate in the separations between adjacent columns provides breathability to the heater.

### BRIEF DESCRIPTION OF THE FIGURES

FIG. 1 illustrates an embodiment of a printed heater, the heater comprising a substrate with two bus bars, an array of printed resistive material rectangles arranged in columns between the two bus bars with spaces between adjacent resistive material rectangles in a column and a separation between adjacent columns and an array of printed electrically conductive rectangles with a conductive rectangle positioned to fill the space between, to overlap, to be contiguous to and provide electrical contact to every adjacent pair of resistive material rectangles in a column.

FIG. 2 is a drawing showing the details of FIG. 1, i.e., the individual rectangles of printed resistive material and rectangles of conductive material within a column as well as the separation between adjacent columns.

FIG. 3 illustrates an embodiment of a printed heater, the heater comprising a substrate with two bus bars and an array of printed columns of resistive material and a separation between adjacent columns.

### DETAILED DESCRIPTION OF THE INVENTION

The invention relates to an improved printed heater that can be used to heat a variety of articles. The issues with printing large areas of resistive material is resolved by using an array of small areas of resistive material each of which serves as an individual heater instead of a single heater with a large area resistive material layer. The ability to print numerous smaller areas of resistive material results in more uniform areas of resistive material and therefore improved performance of the individual heaters and the heater comprising these individual heaters. The articles include wearable garments, seats and parts of electric automobiles.

In addition, when the substrate upon which the heater is printed is permeable, the heater has the additional advantage of being breathable in the sense that air and moisture, i.e., water vapor, can pass through the exposed regions of the permeable substrate in the separations between adjacent columns. This can provide additional comfort to the wearer of a garment containing the heater. The wearable garment itself may be comprised of a permeable fabric upon which the heater is printed or the heater may be printed on a permeable polymer or permeable fabric substrate which is attached to the garment. Openings can be made in the regions of the substrate not covered by the individual heaters, i.e., the area between the individual heaters, to provide additional breathability if the substrate is permeable or to provide breathability if the substrate is not permeable.

As used herein, “two bus bars” is used to refer to printed conductors that connect to and provide voltages to the printed columns of resistive material. There are two bus bars for each heater with a voltage applied across them. In some embodiments it may be convenient to separate a bus bar into separate portions. Such embodiments are included in the “two bus bar” usage.

### Configuration A

In this configuration, the heater comprises a substrate, two printed bus bars, an array of printed resistive material areas arranged in columns between the two bus bars with spaces between adjacent resistive material areas in a column and with a separation between adjacent columns, wherein the resistive material areas nearest to the bus bars overlap and are in electrical contact with the bus bars, and an array of printed conductive areas, wherein a conductive area is positioned to fill the space between, to overlap, and to be contiguous to and provide electrical contact with every adjacent pair of resistive material areas in a column. The portions of the resistive material not in contact with the conductive areas provide the heating. The heater does not contain interdigitated electrodes. The conductive areas and the bus bars can be printed onto the substrate before or after the resistive material areas. If the substrate is permeable, the exposed permeable substrate in the separations between adjacent columns renders the heater breathable. Openings can be made in the regions of the substrate not covered by the individual heaters, i.e., the area between the individual heaters, to provide additional breathability if the substrate is permeable or to provide breathability if the substrate is not permeable.

In some embodiments, the printed conductive areas and bus bars are silver areas and silver bus bars and the printed resistive material is carbon. In other embodiments, the printed conductive areas and bus bars are copper areas and copper bus bars and the printed layer of resistive material is carbon. In still other embodiments, the printed conductive areas and bus bars are silver-silver chloride, gold or aluminum.

The electrically conductive areas and bus bars referred to herein are formed from polymer thick film pastes containing an electrical conductor. When the printed conductive areas and bus bars are silver, they are formed using polymer thick film silver pastes. The resistive material is also printed using a polymer thick film paste. When the printed resistive material is printed carbon it is formed using a polymer thick film carbon paste. When using polymer thick film pastes, the polymer is an integral part of the final composition, i.e., the conductive material, the bus bar or the resistive material.

The heater resistance R_{H} is a primary factor for determining the performance of the heater. R_{H} depends on a number of geometrical parameters in addition to the sheet resistance Rₛ of the resistive material. The geometrical parameters are the dimensions of the resistive material areas, the distances between the resistive areas in a column, the numbers of resistive areas in a column and the number of columns. These parameters have design limitations dictated by the printing process and its limits of resolution as well as by the overall size of the heater.

In one embodiment, each individual resistive material area is in the form of a rectangle with width W and effective length L_{eff}. The effective length L_{eff} of the resistive material rectangle is the length of the resistive material between the overlapping contiguous conductive areas on the two sides of the resistive material rectangle. Each resistive material rectangle has essentially the same sheet resistance Rₛ and the spaces between the resistive material rectangles in a column are essentially identical. Each column has M resistive material rectangles. Each conductive area is in the form of a rectangle with width w and length l. There are N columns and a separation d between adjacent columns. This embodiment will be discussed further with reference to the Figures.

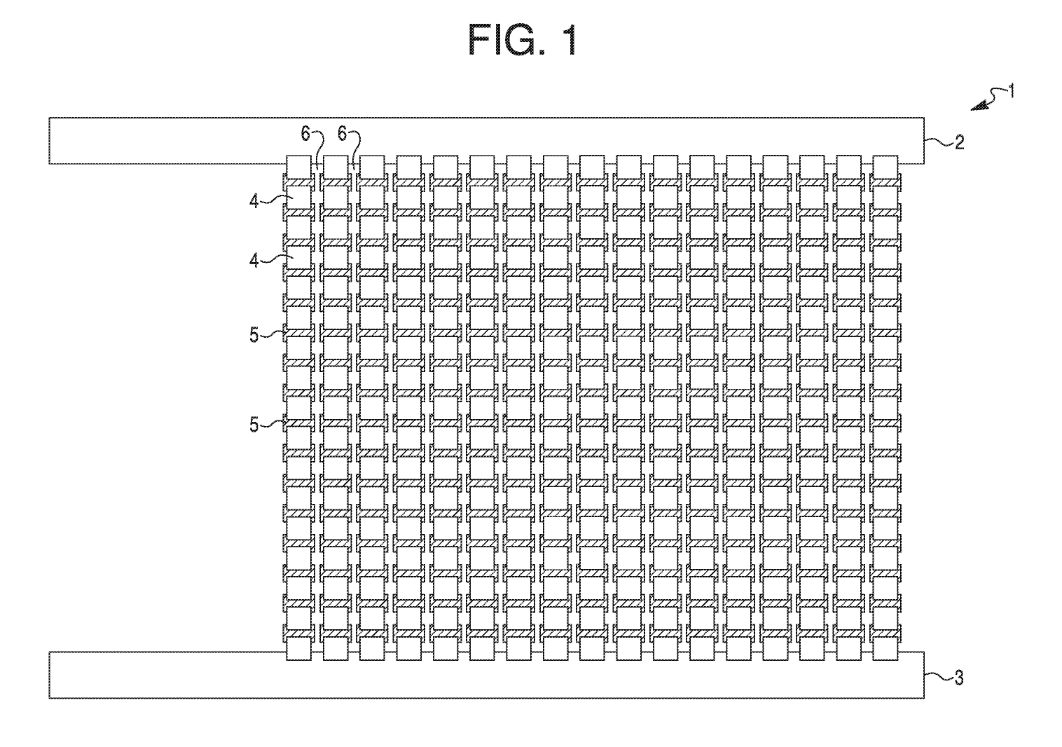

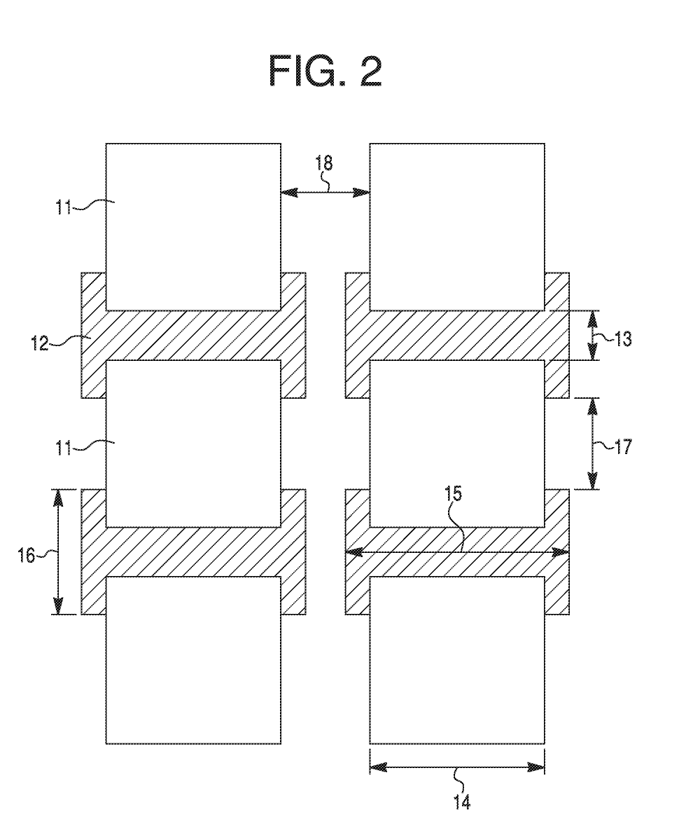

FIG. 1 illustrates the embodiment of a heater 1 described above. There are two printed bus bars 2 and 3. There is an array of printed resistive material areas in the form of rectangles 4 arranged with uniform spacing in columns as shown in FIG. 1, wherein the resistive material areas nearest to the bus bars overlap and are in electrical contact with the bus bars. There are spaces 5 of length s between adjacent resistive material rectangles 4 in a column. There are M resistive material rectangles in a column. In the columns shown in FIG. 1 there are seventeen such resistive material rectangles, i.e., M=17 for FIG. 1. There are also seventeen columns shown in FIG. 1, i.e., N=17. There is an array of printed conductive rectangles. A conductive rectangle is positioned to fill the space 5 (length s) between and overlap and be contiguous to and provide electrical contact to every adjacent pair of resistive material rectangles in a column. There are M−1 conductive rectangles in each column. The exposed substrate 6 is present between the columns. Details are shown more clearly in FIG. 2.

FIG. 2 shows six resistive material rectangles 11, three in one column and three in an adjacent column. Also shown are electrically conductive areas in the form of rectangles 12. As shown in FIG. 2, the conductive rectangles 12 have been printed first and the resistive rectangles 11 printed second. The electrically conductive rectangles fill the space 13 (length s) between the resistive material rectangles as well as overlapping and being contiguous to and providing electrical contact with the pair of adjacent resistive rectangles 11. The width W of the resistive material rectangles is indicated by 14. The width w of the conductive rectangles is indicated by 15. w is shown greater than W to ease the tolerance in printing the resistive material rectangles. The length l of the conductive rectangle is indicated by 16 and is greater than the space 13 so as to provide overlap with the pair of adjacent resistive rectangles and be contiguous to them and make good electrical contact. The effective length L_{eff} of the resistive material rectangle is indicated by 17. The distanced between columns is indicated by 18.

The resistance of each resistive material rectangle is R_{rect} and R_{rect}=Rₛ×L_{eff}/W. The resistive material rectangles in a column are electrically in series and, with M resistive material rectangles in a column, the column resistance R_{col}=R_{rect}×M. The N columns are electrically parallel so that the total heater resistance R_{H}=Rₛ (L_{eff} M)/(W N).

As an example, if the resistive material rectangle is a printed carbon rectangle with Rₛ=30 Ω/square and L_{eff}/W=0.67, R_{rect}=20Ω. If M=25 and N=50, R_{H}=10Ω. A 12-volt battery can supply about 14 Watts of power to the heater which is an appropriate amount for a wearable heater. Different size heaters with different numbers and sizes of resistive areas and/or numbers of columns can be used to heat other articles.

### Configuration B

In this configuration, the heater comprises a substrate, two printed bus bars and an array of printed columns of resistive material between the two bus bars with a separation between adjacent columns. In contrast to Configuration A, the column of resistive material is continuous from one bus bar to the other, with no separations and no conductive material between the two bus bars. The columns of resistive material overlap and are in electrical contact with each bus bar. The heater does not contain interdigitated electrodes. The bus bars can be printed onto the substrate before or after the resistive material columns. If the substrate is permeable, the exposed permeable substrate in the separations between adjacent columns renders the heater breathable. Openings can be made in the regions of the substrate between the columns of resistive material to provide additional breathability if the substrate is permeable or to provide breathability if the substrate is not permeable.

In some embodiments, the printed bus bars are silver bus bars and the printed resistive material is carbon. In other embodiments, the printed bus bars are copper bus bars and the printed layer of resistive material is carbon. In still other embodiments, the printed bus bars are silver-silver chloride, gold or aluminum.

As indicated above, the bus bars and the resistive material columns referred to herein are formed from polymer thick film pastes.

The heater resistance R_{H} is a primary factor for determining the performance of the heater. R_{H} depends on a number of geometrical parameters in addition to the sheet resistance Rₛ of the resistive material. The geometrical parameters are the dimensions of the resistive material columns and the number of columns. These parameters have design limitations dictated by the printing process and its limits of resolution as well as by the overall size of the heater.

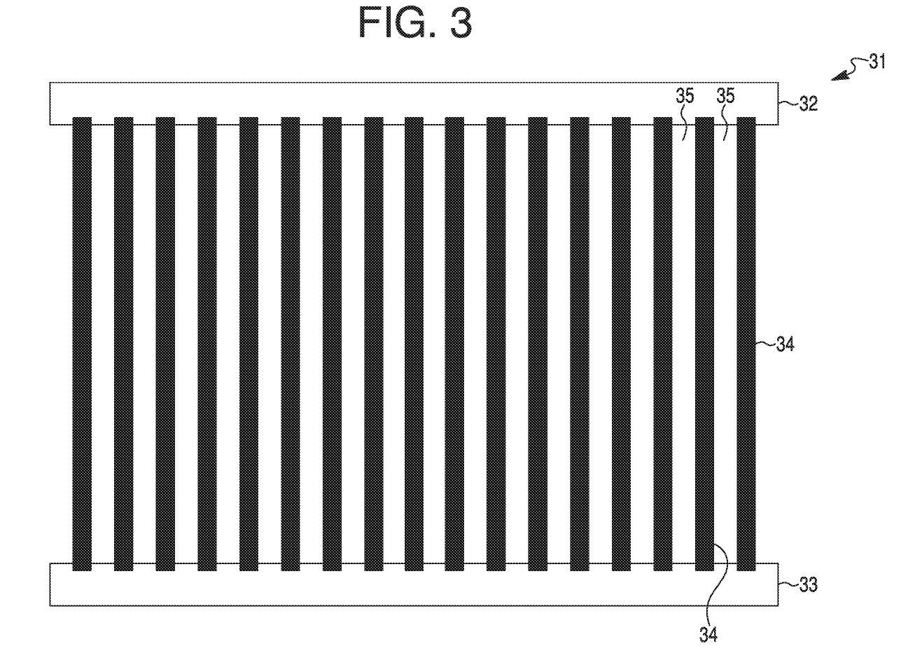

FIG. 3 illustrates the embodiment of a heater 31 described above. There are two printed bus bars 32 and 33. Each individual resistive material column 34 has a width W and an effective length L_{eff}, the distance between the two bus bars. There are N columns of resistive material and these columns are perpendicular to the bus bars as shown. As shown in FIG. 3, there are seventeen columns, i.e., N=17. There is a separation d of exposed substrate 35 between adjacent columns.

The resistance of each resistive material column is R_{col} and R_{col}=Rₛ×L_{eff}/W. The N columns are electrically parallel so that the total heater resistance R_{H}=Rₛ (L_{eff})/(W N).

As an example, if the resistive material rectangle is a printed carbon rectangle with Rₛ=30 Ω/square and L_{eff}/W=16, R_{col}=480Ω. If N=48, R_{H}=10Ω. A 12-volt battery can supply about 14 Watts of power to the heater which is an appropriate amount for a wearable heater. Different size heaters with different numbers and sizes of resistive columns can be used to heat other articles.

### Configuration C

In this configuration, the heater comprises a substrate, two printed bus bars, an array of printed resistive material areas arranged in columns between the two bus bars and with a separation between adjacent columns, wherein the resistive material areas nearest to the bus bars overlap and are in electrical contact with the bus bars. The heater also comprises an array of printed conductive areas, wherein the conductive areas are positioned at intervals along each resistive material column to be contiguous to and provide electrical contact with the electrical resistive material column. The heater does not contain interdigitated electrodes. The conductive areas and the bus bars can be printed onto the substrate before or after the resistive material areas.

If the substrate is permeable, the exposed permeable substrate in the separations between adjacent columns renders the heater breathable. Openings can be made in the regions of the substrate not covered by the individual heaters, i.e., the area between the individual heaters, to provide additional breathability if the substrate is permeable or to provide breathability if the substrate is not permeable.

In some embodiments, the printed conductive areas and bus bars are silver areas and silver bus bars and the printed resistive material is carbon. In other embodiments, the printed conductive areas and bus bars are copper areas and copper bus bars and the printed layer of resistive material is carbon. In still other embodiments, the printed conductive areas and bus bars are silver-silver chloride, gold or aluminum.

As indicated above, the bus bars and conductive areas and the resistive material columns referred to herein are formed from polymer thick film pastes.

The heater resistance R_{H} is a primary factor for determining the performance of the heater. R_{H} depends on a number of geometrical parameters in addition to the sheet resistance Rₛ of the resistive material. The geometrical parameters are the dimensions of the resistive material columns, the numbers of and the distances between the conductive areas along the column, the dimensions of the conductive areas and the number of columns. These parameters have design limitations dictated by the printing process and its limits of resolution as well as by the overall size of the heater.

In one embodiment, each individual resistive material column is perpendicular to the two parallel bus bars and overlaps and is in electrical contact with each bus bar. Each resistive column has a width W. Each resistive column has essentially the same sheet resistance Rₛ. Each conductive area is in the form of a rectangle with width w and length l. The conductive rectangles are spaced uniformly along each resistive material column so that the distances between the rectangles is the same. The conductive rectangles are contiguous to and make electrical contact with the resistive column. Each conductive rectangle has a width w and a length. There are M−1 conductive rectangles along each column and M resistive portions along the column not in contact with a conductor. It is these resistive portions, referred to herein as tiles, that provide the heating. The effective length L_{eff} of each of the resistive tiles is the length of the resistive material between two neighboring conductive rectangles. There are N columns and a separation d between adjacent columns.

The resistance of each resistive material tile is Rₜᵢₗₑ and Rₜᵢₗₑ=Rₛ×L_{eff}/W. The resistive material tiles in a column are electrically in series and, with M resistive material tiles in a column, the column resistance R_{col}=Rₜᵢₗₑ×M. The N columns are electrically parallel so that the total heater resistance R_{H}=Rₛ (L_{eff} M)/(W N).

As an example, if the resistive material tile is a printed carbon tile with Rₛ=30 Ω/square and L_{eff}/W=0.67, Rₜᵢₗₑ=20Ω. If M=25 and N=50, R_{H}=10Ω. A 12-volt battery can supply about 14 Watts of power to the heater which is an appropriate amount for a wearable heater. Different size heaters with different numbers and sizes of resistive areas and/or numbers of columns can be used to heat other articles.

### EXAMPLES

### Example 1

A heater with the Configuration A shown in FIG. 1 was made and tested. The overall dimensions of the heater were 250 mm in width and 170 mm in height. The heater was printed on a clear thermoplastic polyethylene terephthalate (PET) substrate with a thickness of 0.2 mm. Referring to FIGS. 1 and 2, the printed resistive material rectangles 4 and 11 were made of printed carbon paste (DuPont™ 7105, DuPont Co., Wilmington, Del.) with a sheet resistivity of 22 Ohms/square. The number of resistive rectangles 4 and 11 in each column was nineteen, M=19, and there were forty-eight columns, N=48. There were two identical conductive bus bars 2 and 3, with lengths of 250 mm and widths of 15 mm. There was a 1 mm overlap of the bus bars with the adjacent printed resistive material rectangles. Each column had eighteen electrically conductive printed rectangles 5 and 12. The bus bars and the conductive rectangles were made of printed silver paste (DuPont™ 5025 Silver Conductor, DuPont Co., Wilmington, Del.) with resistivity of 20 mOhms/square. The conductive rectangles 5 and 12 overlapped and were contiguous to and provided electrical contact to the adjacent resistive rectangles 4 and 11. There was an overlap of 1 mm between the adjacent electrically conductive rectangles and resistive rectangles. Each electrically conductive rectangle was 4.5 mm wide and 4 mm high. The width W 14 of a resistive rectangle 5 and 12 was 4 mm and the total height was 6 mm, which included the two overlaps, so that L_{eff} 17 was 4 mm. The lateral distance d 18 between columns was 1 mm.

The total heater resistance was measured to be 8.9 Ohms. This measured figure was very close to the 8.7 Ohms calculated from the heater resistance equation R_{H}=Rₛ (L_{eff} M)/(W N) given previously for this configuration.

The printed heaters of this example were laboratory tested for electrical and thermal properties. The thermal tests were done with the heater in open air in ambient conditions. The maximum temperatures achieved as measured by an infrared camera versus applied voltage are shown in the Table I below.

TABLE I

| | Max Temperature |
|---|---|
| Applied Voltage (V) | Infrared Camera (° C.) |
| 0 | 22 |
| 6 | 33 |
| 9 | 46 |
| 10 | 50 |
| 12 | 60 |
| 13 | 64 |
| 15 | 74 |

### Example 2

A heater with the Configuration C was made and tested. The heater was printed on a clear thermoplastic polyethylene terephthalate (PET) substrate with a thickness of 0.2 mm. The printed resistive material columns were made of printed carbon paste (DuPont™ 7105, DuPont Co., Wilmington, Del.) with a sheet resistivity of 22 Ohms/square. There were forty-eight resistive material columns, N=48, and each column had a width W of 4 mm. The lateral distance between columns was 1 mm. There were two identical conductive bus bars with lengths of 250 mm and widths of 15 mm. Each resistive material column overlapped and made electrical contact with the bus bars. There were 18 conductive rectangles spaced uniformly along the length of a column of resistive material. Each conductive rectangle had a width w of 4 mm and length l of 3 mm. The bus bars and the conductive rectangles were made of printed silver paste (DuPont™ 5025 Silver Conductor, DuPont Co., Wilmington, Del.) with resistivity of 20 mOhms/square. The conductive rectangles were uniformly space with a distance of 4 mm between rectangles so the effective length L_{eff} of a tile was 4 mm. There was a tile adjacent to each bus bar so that there were 19 resistive tiles in each column, i.e., M=19.

The total heater resistance was measured to be 8.9 Ohms. This measured figure was very close to the 8.7 Ohms calculated from the heater resistance equation R_{H}=Rₛ (L_{eff} M)/(W N) given previously for this configuration.

The printed heaters of this example were laboratory tested for electrical and thermal properties. The thermal tests were done with the heater in open air in ambient conditions. The maximum temperatures achieved as measured by an infrared camera versus applied voltage are shown in the Table II below.

TABLE II

| Applied Voltage (V) | Max Temperature (° C.) |
|---|---|
| 0 | 22 |
| 6 | 31 |
| 9 | 44 |
| 10 | 50 |
| 12 | 61 |
| 13 | 63 |
| 15 | 75 |

What is claimed is:

1. An article containing a printed heater, the heater comprising:
a) a substrate;
b) two printed bus bars;
c) an array of printed resistive material areas arranged in columns between the two bus bars with spaces between adjacent resistive material areas in a column and with a separation between adjacent columns; and
d) an array of printed conductive areas, wherein a conductive area is positioned to fill the space between and overlap and be contiguous to and provide electrical contact with every adjacent pair of resistive material areas in a column, wherein the portions of the resistive material areas along the column not in contact with the conductive areas form resistive regions that provide the heating and wherein the conductive areas and the bus bars can be printed onto the substrate before or after the resistive material areas.

2. The article of claim 1, wherein each individual resistive material area is in the form of a rectangle with width W and effective length L_{eff}, each resistive material rectangle has essentially the same sheet resistance Rₛ, the spaces between adjacent pairs of resistive material rectangles in a column are essentially identical, each column has M resistive material rectangles, and wherein each of the M−1 conductive areas in a column is in the form of a rectangle with width w and length l and wherein there are N columns.

3. The article of claim 1, wherein the printed bus bars are silver bus bars, the printed resistive material is carbon and the printed conductive areas are silver.

4. The article of claim 1, wherein the article is a wearable garment.

5. The article of claim 4, wherein the heater is permeable.

6. The article of claim 1, wherein the article is a seat.

7. The article of claim 1, wherein the article is a part of an electric automobile.

8. An article containing a printed heater, the heater comprising:
a) a substrate;
b) two printed bus bars; and
c) an array of printed columns of resistive material between the two bus bars with a separation between adjacent columns, wherein the columns of resistive material overlap and are in electrical contact with each bus bar and wherein the bus bars can be printed onto the substrate before or after the resistive material columns.

9. The article of claim 8, wherein each individual resistive material column has a width W and an effective length L_{eff}, each resistive material column has essentially the same sheet resistance Rₛ, and wherein there are N columns.

10. The article of claim 8, wherein the printed bus bars are silver bus bars and the printed resistive material is carbon.

11. The article of claim 8, wherein the article is a wearable garment.

12. The article of claim 11, wherein the heater is permeable.

13. The article of claim 8, wherein the article is a seat.

14. The article of claim 8, wherein the article is a part of an electric automobile.

15. An article containing a printed heater, the heater comprising:
a) a substrate;
b) two printed bus bars;
c) an array of printed columns of resistive material between the two bus bars with a separation between adjacent columns, wherein the columns of resistive material overlap and are in electrical contact with each bus bar; and
d) an array of printed conductive areas, wherein the conductive areas are positioned at intervals along each resistive material column to be contiguous to and provide electrical contact with the electrical resistive material column, wherein the portions of the resistive material along the column not in contact with the conductive areas form resistive tiles that provide the heating and wherein the conductive areas and the bus bars can be printed onto the substrate before or after the resistive material columns.

16. The article of claim 15, wherein each individual resistive material tile is in the form of a rectangle with width W and effective length L_{eff}, each resistive material tile has essentially the same sheet resistance Rₛ, there are M−1 conductive areas spaced uniformly along the column in the form of rectangles w wide and l long, there are M resistive portions along the column that are not in contact with the conductive rectangles and form resistive tiles W wide and L_{eff} long where L_{eff} is the length of the resistive material between two neighboring conductive rectangles and wherein there are N columns.

17. The article of claim 15, wherein the printed bus bars are silver bus bars, the printed resistive material is carbon and the printed conductive areas are silver.

18. The article of claim 15, wherein the article is a wearable garment.

19. The article of claim 18, wherein the heater is permeable.

20. The article of claim 15, wherein the article is a seat.

21. The article of claim 15, wherein the article is a part of an electric automobile.
